(19) United States
(12) Patent Application Publication
(10) Pub. No.: US 2025/0117534 A1
(43) Pub. Date: Apr. 10, 2025

(54) DESIGN METHOD FOR ROPS FRAMEWORK AND CAB FOR ENGINEERING MACHINES

(71) Applicant: JIANGSU XCMG CONSTRUCTION MACHINERY RESEARCH INSTITUTE LTD., Xuzhou, Jiangsu (CN)

(72) Inventors: Lanzhong YANG, Xuzhou, Jiangsu (CN); Younian FANG, Xuzhou, Jiangsu (CN); Yilin LU, Xuzhou, Jiangsu (CN)

(73) Assignee: JIANGSU XCMG CONSTRUCTION MACHINERY RESEARCH INSTITUTE LTD., Xuzhou, Jiangsu (CN)

(21) Appl. No.: 18/248,433

(22) PCT Filed: Jul. 29, 2022
(86) PCT No.: PCT/CN2022/108856

§ 371 Date: Apr. 10, 2023

(30) Foreign Application Priority Data
Jun. 29, 2022 (CN) 202210749402.6

(51) Int. Cl. G06F 30/15; B60R 21/13; G06F 119/14

(52) U.S. Cl. CPC G06F 30/15; B60R 21/131; G06F 2119/14

(57) ABSTRACT

Disclosed are a design method for an ROPS framework and a cab for engineering machines. The design method for an ROPS framework comprises: obtaining target values of a lateral load Fₘₐₓ and lateral load energy Uₘₐₓ of an ROPS framework by calculation according to the standards of earth-moving machines; selecting a suitable cab framework structure type from a simply supported beamstructural mechanics model; and calculating the sum of profile sectional moduli of all pillars and top cross beams according to a maximum lateral load Fₘₐₓ quick calculation formula and a maximum load energy Uₘₐₓ quick calculation formula, selecting suitable profiles based on the sum, and constructing a closed spatial framework structure according to the selected cab framework structure type.

### FIELD

The invention belongs to the technical field of cabs for engineering machines, and relates to a design method for an ROPS framework and a cab for engineering machines.

### BACKGROUND

Engineering machines work in severe environments and travel along complicated and changeable paths, so rollover accidents happen frequently. Due to the large mass of engineering machines, the possibility of devastating injuries caused in the event of a rollover accident is extremely high, and the primary cause of these devastating injuries is extreme deformation of the cab caused by the accident. Rollover accidents are inevitable, and in order to reduce the loss of life and property caused by the accidents, the most effective and simplest method is to take passive protection, that is, to add a rollover protective structure (ROPS) on vehicles to provide safety protection.

At present, cab ROPS frameworks of engineering machines are generally designed through 3D mathematical model-based simulation analysis and prototype verification, which has the problems that designers cannot reasonably design the structure of the ROPS frameworks and select profiles at the initial stage of a project, a 3D mathematical model is modified repeatedly, and the simulation cycle is long.

According to the 3D mathematical model-based simulation analysis method widely used in the industry at present, after designers design a 3D mathematical model of a cam framework, simulation analysts complete simulation analysis according to ROPS loading requirements by means of computer-assisted analysis software such as HYPERMESH and ANSYS, and then the designers modify the 3D mathematical model according to the simulation result (the load capacity of the ROPS is inadequate or excessive). This communication process is generally repeated two to three times, each taking one to two weeks, so high-efficiency design work cannot be realized.

The prior art has the following defects: (1) the development cycle of the cab ROPS framework is long; (2) the cab ROPS framework is designed after the 3D mathematical model is completed by designers, and structural design of the cab framework and profile selection obtained at the initial design stage are not applicable; and (3) simulation analysis resources are occupied for a long time, so the design cost is high.

### SUMMARY

Objective: to overcome the defects of the prior art, the invention provides a design method for an ROPS framework and a cab for engineering machines.

Technical solution: the technical solution adopted by the invention to solve the above technical problems is as follows:

In a first aspect, the invention provides a design method for an ROPS framework, which comprises:

Obtaining, by calculation specified in GB/T 17922, GB/T 19930 or GB/T19930.2, target values of a lateral load Fₘₐₓ and lateral load energy Uₘₐₓ of an ROPS framework according to maximum mass of applicable machines of the ROPS framework;
selecting, according to features of applicable machines of a cab, a suitable cab framework structure type from a simply supported beam structural mechanics model, wherein the simply supported beam structural mechanics model comprises a common cab framework structure, a framework structure reinforced with a middle cross beam, or a framework structure reinforced with cable-stayed beams;

Based on the suitable framework structure type selected from the simply supported beam structural mechanics model and the target values of the lateral load Fₘₐₓ and the lateral load energy Uₘₐₓ obtained by calculation, obtaining two profile sectional modulus sum values by calculation according to a maximum lateral load Fₘₐₓ quick calculation formula and a maximum load energy Uₘₐₓ quick calculation formula, and taking the greater one of the two profile sectional modulus sum values as a final profile sectional modulus sum of all pillars and top cross beams meeting a relation; and

Selecting suitable profiles according to the profile sectional modulus sum, and constructing a closed spatial framework structure according to the selected cab framework structure type.

In some embodiments, the maximum load energy Uₘₐₓ quick calculation formula is:

$${U}_{max} = 1.5 \cdot {S}_{max} \cdot K \cdot {σ}_{tensile stress} \cdot \sum \{ ( {W}_{A \_ pillar} + {W}_{top \_ Across beam} ) / {L}_{A} , ( {W}_{B \_ pillar} + {W}_{t op \_ Bcross beam} ) / {L}_{B} , n \cdot ( {W}_{D \_ pillar} + {W}_{t op \_ Dcross beam} ) / {L}_{D} \} = 0.42 \cdot K \cdot {σ}_{tensile stress} \cdot \sum \{ ( {W}_{A \_ pillar} + {W}_{t op \_ Across beam} ) / {L}_{A} , ( {W}_{B \_ pillar} + {W}_{t op \_ Bcross beam} ) / {L}_{B} , n \cdot ( {W}_{D \_ pillar} + {W}_{t op \_ Dcross beam} ) / {L}_{D} \}$$

The maximum lateral load Fₘₐₓ quick calculation formula is:

$${F}_{max} = 2 \cdot K \cdot {σ}_{tensile stress} \cdot \sum \{ ( \sum \{ ( {W}_{A \_ pillar} + {W}_{t op \_ Across beam} ) / {L}_{A} , ( {W}_{B \_ pillar} + {W}_{t op \_ Bcross beam} ) / {L}_{B} , n \cdot ( {W}_{D \_ pillar} + {W}_{t op \_ Dcross beam} ) / {L}_{D} \}$$

Where, n is a structure reinforcing coefficient and is determined according to the selected cab framework structure type;
The target values of the lateral load Fₘₐₓ and the lateral load energy Uₘₐₓ obtained by calculation are used as Fₘₐₓ and Uₘₐₓ;
K denotes a complete plastic deformation zone reinforcing coefficient and is obtained by regression analysis according to the maximum lateral load Fₘₐₓ in test data;
The maximum deformation displacement Sₘₐₓ is a median of normal statistical data in the test data;
σ_{tensile stress} denotes a tensile stress limit value of a material and is a fixed value according to the selected material;
L_{A}, L_{B}, L_{D} and L_{d} are given values according to the selected cab framework structure type, and respectively denote a height dimension of A-pillars, a height dimension of B-pillars, a height dimension of D-pillars, and a height dimension from highest points of D-pillars to highest points of cable-stayed beams of the framework structure reinforced with the cable-stayed beams.

In some embodiments, n is the structure reinforcing coefficient and is determined according to the selected cab framework structure type:
Common cab framework structure: n=1;
Framework structure reinforced with a middle cross beam: n=(Wₚᵢₗₗₐᵣ+W_{top_cross beam}+W_{middle_cross beam})/(W_{D_pillar}+W_{top_Dcrossbeam});
Framework structure reinforced with cable-stayed beams: n=L_{D}/L_{d}.

In some embodiments, the maximum lateral load Fₘₐₓ quick calculation formula and the maximum load energy Uₘₐₓ quick calculation formula are established by:
S1, establishing a mechanics model: with a lateral load F and lateral load energy U required by an ROPS test as design objectives, establishing a relation of the lateral load F and the lateral load energy U with profile anti-bending geometric parameters to obtain the simply supported beam structural mechanics model, and obtaining a bending moment equilibrium formula by analysis with the simply supported beam structural mechanics model, wherein the sum of resisting moments of plastic hinges is a bending moment generated by the load;
S2, selecting design parameters: analyzing the bending moment equilibrium formula to obtain a profile anti-bending geometric parameter, sectional modulus W, which is a key factor determining a maximum load capacity Mₘₐₓ of ROPS framework profiles, wherein a relation between the sectional modulus W and the maximum load capacity Mₘₐₓ is Mₘₐₓ=K·σₜₑₙₛᵢₗₑₛₜᵣₑₛₛ·W;
Substituting Mₘₐₓ=K·σₜₑₙₛᵢₗₑₛₜᵣₑₛₛ·W into the bending moment equilibrium formula obtained in S1 to obtain a maximum lateral load formula of the ROPS framework;
S3, obtaining test data when the framework profiles enter a complete deformation zone during the ROPS lateral thrust test, extracting the maximum lateral load Fₘₐₓ, the maximum lateral load energy Uₘₐₓ and the maximum deformation displacement Sₘₐₓ in the test data, and using a median of normal statistical data in the test data as the maximum deformation displacement Sₘₐₓ;
S4, obtaining the value of K in the relation established in S2 by regression analysis according to the maximum lateral load Fₘₐₓ extracted from the test data to obtain the maximum lateral load Fₘₐₓ quick calculation formula of the ROPS framework, which is expressed as:

$${F}_{max} = 2 \cdot K \cdot {σ}_{tensile stress} \cdot \sum \{ ( \sum \{ ( {W}_{A \_ pillar} + {W}_{t op \_ Across beam} ) / {L}_{A} , ( {W}_{B \_ pillar} + {W}_{t op \_ Bcross beam} ) / {L}_{B} , n \cdot ( {W}_{D \_ pillar} + {W}_{t op \_ Dcross beam} ) / {L}_{D} \}$$

Where, n is a structure reinforcing coefficient;
Common cab framework structure: n=1;
Framework structure reinforced with a middle cross beam: n=(Wₚᵢₗₗₐᵣ+W_{top_cross beam}+W_{middle_cross beam})/(W_{D_pillar}+W_{top_Dcrossbeam});
Framework structure reinforced with cable-stayed beams: n=L_{D}/L_{d};
Obtaining, by statistically analyzing a relation curve of the lateral load F and lateral deformation displacement S in a database established in S3, that load energy absorbed in the plastic deformation zone accounts for ⅔ of total load energy, displacement in the plastic deformation zone accounts for ½ of total deformation displacement and the maximum deformation displacement Sₘₐₓ, which is the median of the normal statistic data, is 0.28 m, such that the maximum load energy Uₘₐₓ quick calculation formula is obtained and expressed as:

$${U}_{max} = 0.75 \cdot {F}_{max} \cdot {S}_{max} = 1.5 \cdot {S}_{max} K \cdot {σ}_{tensile stress} \cdot \sum \{ ( {W}_{A \_ pillar} + {W}_{t op \_ Across beam} ) / {L}_{A} , ( {W}_{B \_ pillar} + {W}_{t op \_ Bcross beam} ) / {L}_{B} , n \cdot ( {W}_{D \_ pillar} + {W}_{t op \_ Dcross beam} ) / {L}_{D} \} = 0.42 \cdot K \cdot {σ}_{tensile stress} \cdot \sum \{ ( {W}_{A \_ pillar} + {W}_{t op \_ Across beam} ) / {L}_{A} , ( {W}_{B \_ pillar} + {W}_{t op \_ Bcross beam} ) / {L}_{B} , n \cdot ( {W}_{D \_ pillar} + {W}_{t op \_ Dcross beam} ) / {L}_{D} \} .$$

In some embodiments, in S1, the simply supported beam structural mechanics model comprises a common cab framework structure, a framework structure reinforced with a middle cross beam, or a framework structure reinforced with cable-stayed beams;

The bending moment equilibrium formula of the simply supported beam structural mechanics model comprising the common cab framework structure is:

$$2 \cdot ( {M}_{pillar} + {M}_{t op \_ cross \_ beam} ) = F \cdot L$$

The bending moment equilibrium formula of the simply supported beam structural mechanics model comprising the framework structure reinforced with the middle cross beam is:

$$2 \cdot ( {M}_{pillar} + {M}_{t op \_ cross beam} + {M}_{middle \_ cross beam} = F \cdot L$$

The bending moment equilibrium formula of the simply supported beam structural mechanics model comprising the framework structure reinforced with the cable-stayed beams is:

$$2 \cdot ( {M}_{pillar} + {M}_{t op \_ cross \_ beam} ) = F \cdot {L}_{d}$$

Where, Mₚᵢₗₗₐᵣ, M_{top_cross beam} and M_{middle_cross beam} are the resisting moment of plastic hinges of pillars, the resisting moment of plastic hinges of top cross beams, and the resisting moment of plastic hinges of the middle cross beam respectively, F is a lateral load of a simply supported beam structure, and L is a height dimension of the pillars;

In S2, the maximum lateral load formula of the ROPS framework is:
a) the maximum lateral load formula of the common cab framework structure:

$${F}_{max} = 2 \cdot K \cdot {σ}_{tensile stress} \cdot ( {W}_{pillar} + {W}_{top \_ Across beam} ) / L$$

b) the maximum lateral load formula of the framework structure reinforced with the middle cross beam:

$${F}_{max} = 2 \cdot K \cdot {σ}_{tensile stress} \cdot ( {W}_{pillar} + {W}_{top \_ cross beam} + {W}_{middle \_ cross beam} ) / L$$

c) the maximum lateral load formula of the framework structure reinforced with the cable-stayed beams:

$${F}_{max} = 2 \cdot K \cdot {σ}_{tensile stress} \cdot ( {W}_{pillar} + {W}_{top \_ cross beam} ) / {L}_{d} .$$

In some embodiments, in S3, the maximum deformation displacement Sₘₐₓ, which is the median of the normal statistical data, is 0.28 m.

In a second aspect, the invention provides ROPS frameworks corresponding to three simply supported beam structural mechanics models:

First: an axially symmetric common cab ROPS framework comprises pillars, cross beams and longitudinal beams;

Wherein, the pillars comprise A-pillars, B-pillars and D-pillars; the cross beams comprise top cross beams and bottom cross beams; the longitudinal beams comprise top longitudinal beams and bottom longitudinal beams;

The two A-pillars are connected through a first top cross beam and a first bottom cross beam to form a closed rectangular A-ring;

The two B-pillars are connected through a second top cross beam and a second bottom cross beam to form a closed rectangular B-ring;

The two D-pillars are connected through a third top cross beam and a third bottom cross beam to form a closed rectangular D-ring;

Four corners of the A-ring and corresponding four corners of the B-ring are connected through a first top longitudinal beam and a first bottom longitudinal beam, and four corners of the B-ring and four corresponding corners of the D-ring are connected through a second top longitudinal beam and a second bottom longitudinal beam, such that a closed spatial framework structure is formed;

The ROPS framework is designed through the design method for an ROPS framework.

Second: an axially symmetric ROPS framework reinforced with a middle cross beam comprises pillars, cross beams, longitudinal beams and a middle cross beam;

Wherein, the pillars comprise A-pillars, B-pillars and D-pillars; the cross beams comprise top cross beams and bottom cross beams; the longitudinal beams comprise top longitudinal beams and bottom longitudinal beams;

The two A-pillars are connected through a first top cross beam and a first bottom cross beam to form a closed rectangular A-ring;

The two B-pillars are connected through a second top cross beam and a second bottom cross beam to form a closed rectangular B-ring;

The two D-pillars are connected through a third top cross beam and a third bottom cross beam to form a closed rectangular D-ring; two ends of the middle cross beam are connected to inner sides of middle portions of the two D-pillars respectively, and the third top cross beam, the middle cross beam and the third bottom cross beam are arranged in parallel;

Four corners of the A-ring and corresponding four corners of the B-ring are connected through a first top longitudinal beam and a first bottom longitudinal beam, and four corners of the B-ring and four corresponding corners of the D-ring are connected through a second top longitudinal beam and a second bottom longitudinal beam, such that a closed spatial framework structure is formed;

The ROPS framework is designed through the design method for an ROPS framework.

Third: an axially symmetric ROPS framework reinforced with cable-stayed beams comprises pillars, cross beams, longitudinal beams and two cable-stayed beams;

Wherein, the pillars comprise A-pillars, B-pillars and D-pillars; the cross beams comprise top cross beams and bottom cross beams; the longitudinal beams comprise top longitudinal beams and bottom longitudinal beams;

The two A-pillars are connected through a first top cross beam and a first bottom cross beam to form a closed rectangular A-ring;

The two B-pillars are connected through a second top cross beam and a second bottom cross beam to form a closed rectangular B-ring;

The two D-pillars are connected through a third top cross beam and a third bottom cross beam to form a closed rectangular D-ring;

Each cable-stayed beam has an end connected to an inner side of a middle of one said D-pillar and an end connected to the third bottom cross beam;

Four corners of the A-ring and corresponding four corners of the B-ring are connected through a first top longitudinal beam and a first bottom longitudinal beam, and four corners of the B-ring and four corresponding corners of the D-ring are connected through a second top longitudinal beam and a second bottom longitudinal beam, such that a closed spatial framework structure is formed;

The ROPS framework is designed through the design method for an ROPS framework.

In a third aspect, the invention further provides a cab for engineering machines, which comprises the ROPS framework.

Beneficial effects: the ROPS framework, the design method for the ROPS framework, and the cab for engineering machines provided by the invention have the following advantages:
(1) The selection of profiles and the comparison of multiple schemes can be performed by manual computation according to the maximum lateral load Fₘₐₓ quick calculation formula and the maximum load energy Uₘₐₓ quick calculation formula, and the design time of the ROPS framework is controlled within 4 hours, such that the design cycle is greatly shortened.
(2) Limit values of the load capacity of profiles are fully used, the database is used for establishing the relation and selecting profiles, such that lightweight design of the ROPS framework is realized, and the design quality is improved.

### BRIEF DESCRIPTION OF THE DRAWINGS

FIG. 1 is a flow diagram of a design method for an ROPS framework according to one embodiment of the invention;

FIG. 2 illustrates a common cab ROPS framework structure according to one embodiment of the invention;

FIG. 3 illustrates an ROPS framework structure reinforced with a middle cross beam according to one embodiment of the invention;

FIG. 4 illustrates an ROPS framework structure reinforced with cable-stayed beams according to one embodiment of the invention;

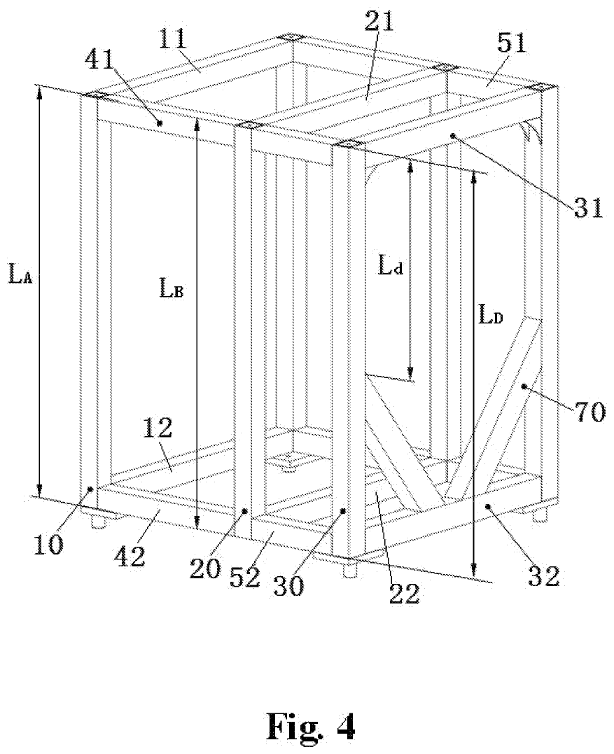

FIG. 5 illustrates a mechanics model of the common cab ROPS framework according to one embodiment of the invention;

FIG. 6 illustrates a mechanics model of the ROPS framework reinforced with the middle cross beam according to one embodiment of the invention;

FIG. 7 illustrates a mechanics model of the ROPS framework reinforced with the cable-stayed beams according to one embodiment of the invention.

### DETAILED DESCRIPTION

The technical solutions of the embodiments of the invention will be clearly and completely described below in conjunction with the accompanying drawings of these embodiments. Obviously, the embodiments in the following description are merely illustrative ones, and are not all possible ones of the invention. The following description of at least one illustrative embodiment is merely explanatory, and should not be construed as any limitation of the invention or the application or use of the invention. All other embodiments obtained by those ordinarily skilled in the art according to the following ones without creative labor should fall within the protection scope of the invention.

Unless otherwise expressly stated, the relative arrangement of components and steps, numeral expressions and numerical values expounded in the embodiments of the invention are not intend to limit the scope of the invention. Moreover, it should be understood that, for the sake of convenient description, the components in the drawings are not drawn according to actual dimension scale. Techniques, methods and devices known by those ordinarily skilled in related art may not be discussed in detail, and in proper cases, these techniques, method and devices should be construed as one part of the granted specification. In all examples illustrated and discussed here, any specific value should be interpreted as illustrative rather than restrictive. Thus, other examples of the illustrative embodiments may have different values. It should be noted that similar reference signs and alphabets represent similar items in the drawings below. Thus, once one item is defined in one drawing, it will not be further discussed in subsequent drawings.

In the description of the disclosure, it should be understood that terms such as “first” and “second” are used for defining parts merely for the purpose of distinguishing corresponding parts. Unless otherwise stated, these terms have no special meanings, and should not be construed as limitations of the protection scope of the disclosure.

In the description of the application, it should be understood that terms such as “central”. “longitudinal”, “cross”, “front”, “back”, “left”, “right”, “vertical”, “horizontal”, “top”, “bottom”, “inner” and “outer” are used to indicate directional or positional relations based on the accompanying drawings merely for the purpose of facilitating and simplifying the description, and do not indicate or imply that devices or elements referred to must be in a specific direction, or be configured and operated in a specific direction, so they should not be construed as limitations of the contents protected by the invention.
ROPS—a rollover protective structure, a series of structural members for reducing the possibility of injuries to a driver wearing a seat belt in the event of a roll-over;
ROPS framework—a spatial framework structure designed to meet ROPS design requirements;
Pillar—a part or component for vertical supporting;
Cross beam—a horizontally arranged beam;
Sectional modulus—a geometric parameter of the section of a component to resist bending deformation;
Plastic hinge—a point appearing on a local part of a component of the ROPS framework subject to a bending moment, of which the opposite side yields but is not destroyed, and around which the component rotates within a limited angle;
Plastic deformation zone—a state where the ROPS framework can no longer sustain a static structure in presence of multiple plastic hinges during lateral loading;

### Embodiment 1

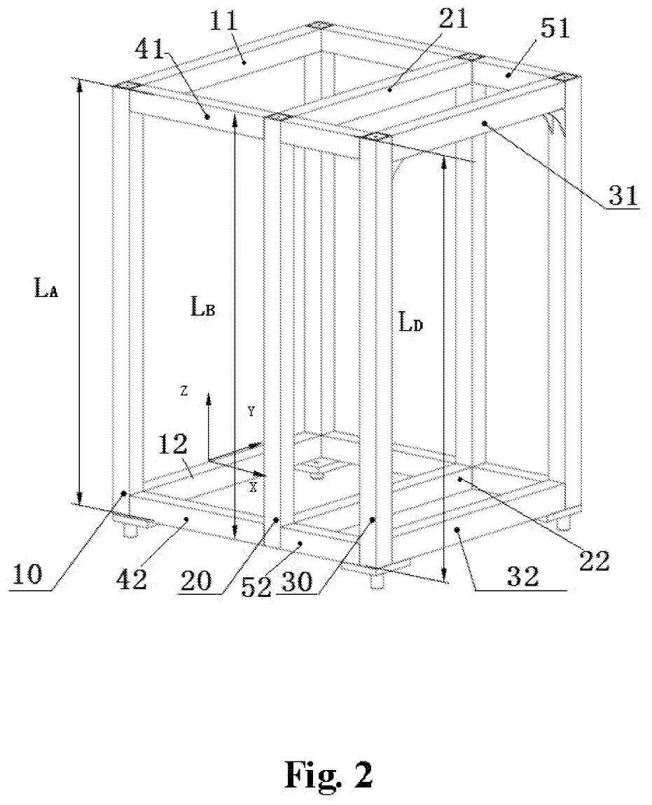

As shown in FIG. 2, an axially symmetric common cab ROPS framework comprises pillars, cross beams and longitudinal beams;

Wherein, the pillars comprise A-pillars 10, B-pillars 20 and D-pillars 30; the cross beams comprise top cross beams and bottom cross beams; the longitudinal beams comprise top longitudinal beams and bottom longitudinal beams;

The two A-pillars 10 are connected through a first top cross beam 11 and a first bottom cross beam 12 to form a closed rectangular A-ring;

The two B-pillars 20 are connected through a second top cross beam 21 and a second bottom cross beam 22 to form a closed rectangular B-ring;

The two D-pillars 30 are connected through a third top cross beam 31 and a third bottom cross beam 32 to form a closed rectangular D-ring;

Four corners of the A-ring and corresponding four corners of the B-ring are connected through a first top longitudinal beam 41 and a first bottom longitudinal beam 42, and four corners of the B-ring and corresponding four corners of the D-ring are connected through a second top longitudinal beam 51 and a second bottom longitudinal beam 52, such as a closed spatial framework structure is formed.

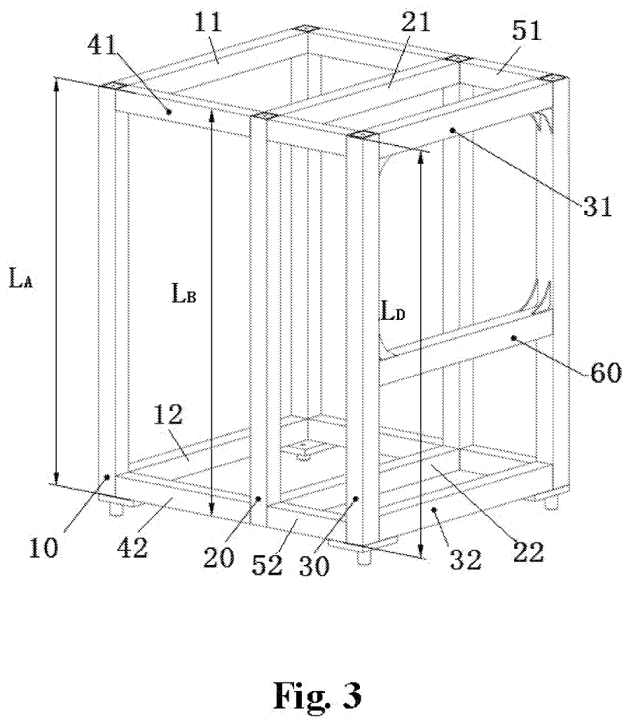

As shown in FIG. 3, an axially symmetric ROPS framework reinforced with a middle cross beam comprises pillars, cross beams, longitudinal beams and a middle cross beam 60;

Wherein, the pillars comprise A-pillars 10, B-pillars 20, and D-pillars 30; the cross beams comprise top cross beams and bottom cross beams; the longitudinal beams comprise top longitudinal beams and bottom longitudinal beams;

The two A-pillars 10 are connected through a first top cross beam 11 and a first bottom cross beam 12 to form a closed rectangular A-ring;

The two B-pillars 20 are connected through a second top cross beam 21 and a second bottom cross beam 22 to form a closed rectangular B-ring;

The two D-pillars 30 are connected through a third top cross beam 31 and a third bottom cross beam 32 to form a closed rectangular D-ring;

Two ends of the middle cross beam 60 are connected to inner sides of middle portions of the two D-pillars respectively, and the third top cross beam, the middle cross beam and the third bottom cross beam are arranged in parallel;

Four corners of the A-ring and corresponding four corners of the B-ring are connected through a first top longitudinal beam 41 and a first bottom longitudinal beam 42, and four corners of the B-ring and corresponding four corners of the D-ring are connected through a second top longitudinal beam 51 and a second bottom longitudinal beam 52, such as a closed spatial framework structure is formed.

As shown in FIG. 3, an axially symmetric ROPS framework reinforced with cable-stayed beams comprises pillars, cross beams, longitudinal beams and two cable-stayed beams 70;

Wherein, the pillars comprise A-pillars 10, B-pillars 20, and D-pillars 30; the cross beams comprise top cross beams and bottom cross beams; the longitudinal beams comprise top longitudinal beams and bottom longitudinal beams;

The two A-pillars 10 are connected through a first top cross beam 11 and a first bottom cross beam 12 to form a closed rectangular A-ring;

The two B-pillars 20 are connected through a second top cross beam 21 and a second bottom cross beam 22 to form a closed rectangular B-ring;

The two D-pillars 30 are connected through a third top cross beam 31 and a third bottom cross beam 32 to form a closed rectangular D-ring;

Each cable-stayed beam 70 has an end connected to an inner side of the middle of one D-pillar 30 and an end connected to the third bottom cross beam 32;

Four corners of the A-ring and corresponding four corners of the B-ring are connected through a first top longitudinal beam 41 and a first bottom longitudinal beam 42, and four corners of the B-ring and corresponding four corners of the D-ring are connected through a second top longitudinal beam 51 and a second bottom longitudinal beam 52, such as a closed spatial framework structure is formed.

In the three ROPS frameworks mentioned above, the A-ring, the B-ring and the D-ring are rectangular structures, and the ROPS frameworks are axially symmetric structures.

Wherein, the longitudinal beams comprise top longitudinal beams and bottom longitudinal beams; to guarantee the flatness of the bottom of the whole ROPS framework, the bottom longitudinal beams and the bottom cross beams are basically located on a same plane (for example, the bottom longitudinal beams and the bottom cross beams are arranged horizontally); however, the length of the A-pillars, the length of the B-pillars and the length of the D-pillars are not definitely identical, so the top longitudinal beams and the top cross beams are not definitely located on a same plane.

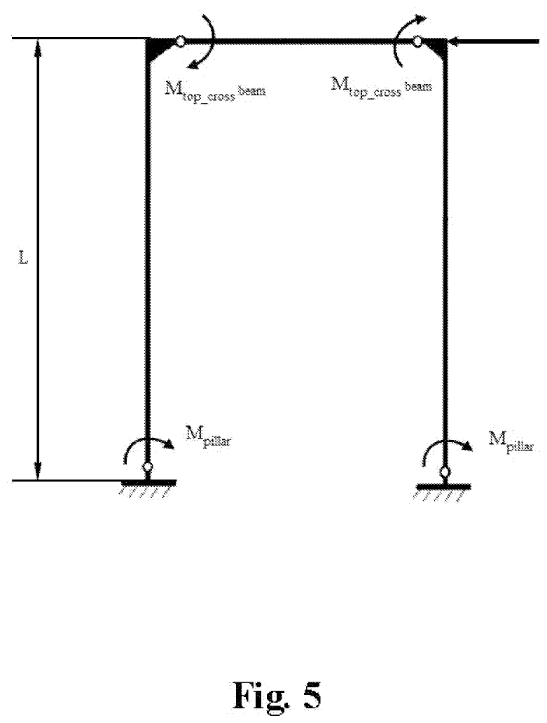

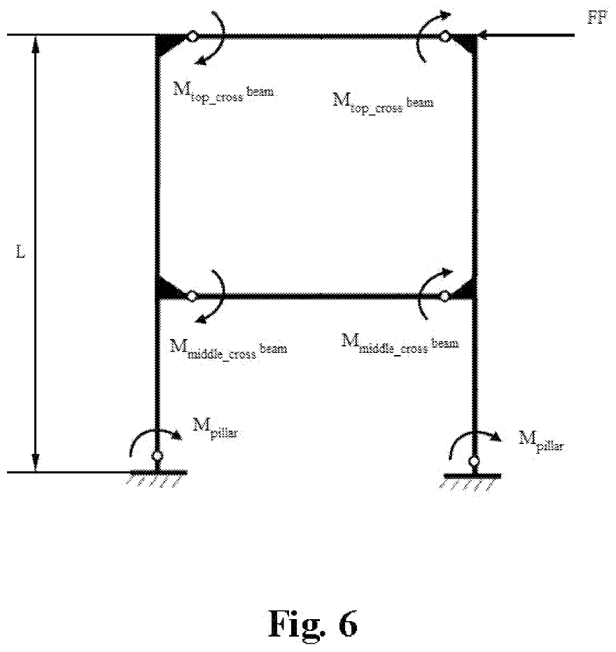

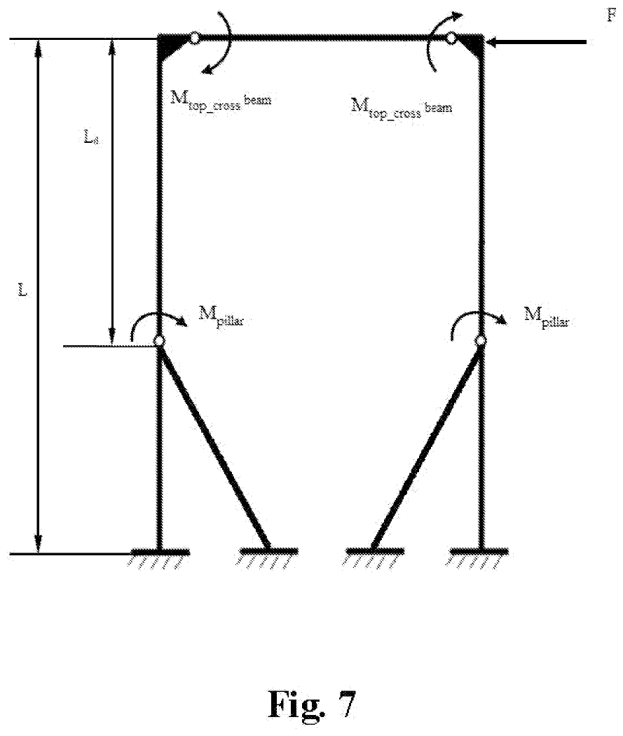

FIG. 5, FIG. 6 and FIG. 7 respectively illustrate a simply supported beam structural mechanics model comprising the common cab framework structure, a simply supported beam structural mechanics model comprising the framework structure reinforced with the middle cross beam, and the simply supported beam structural mechanics model comprising the framework structure reinforced with the cable-stayed beams.

In some embodiments, the sum of profile sectional moduli of all the pillars and top cross beams of the above three ROPS frameworks meets the requirements of a design method in Embodiment 2.

### Embodiment 2

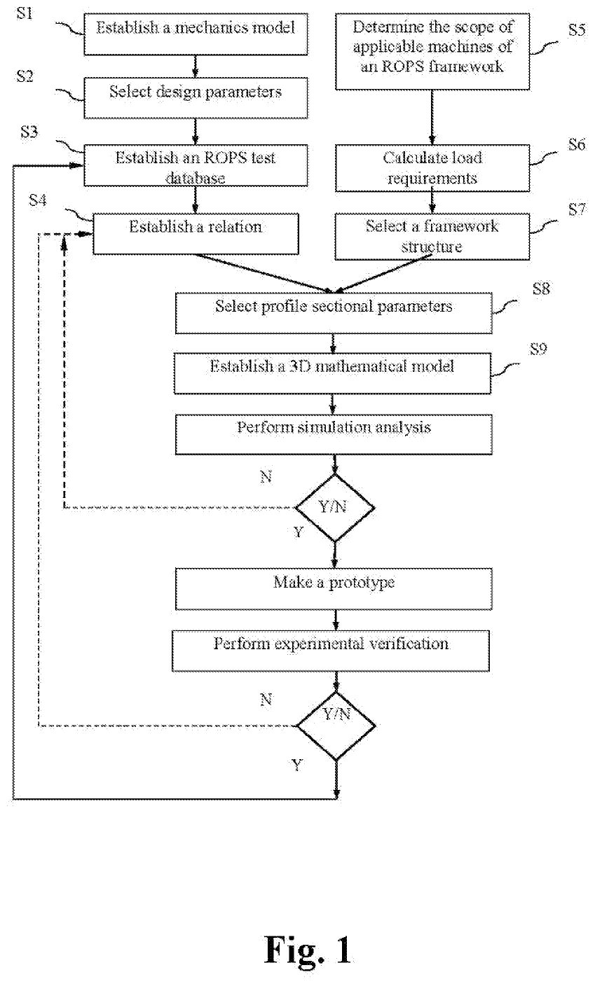

As shown in FIG. 1, a design method for an ROPS framework comprises:
S1, establishing a mechanics model: with a lateral load F and lateral load energy U required by an ROPS test as design objectives, establishing a relation of the lateral load F and the lateral load energy U with profile anti-bending geometric parameters to obtain a simply supported beam structural mechanics model, and obtaining a bending moment equilibrium formula by analysis with the simply supported beam structural mechanics model, wherein the sum of resisting moments of plastic hinges is a bending moment generated by the load;

The simply supported beam structural mechanics model comprises a common cab framework structure, a framework structure reinforced with a middle cross beam, or a framework structure reinforced with cable-stayed beams;

The bending moment equilibrium formula of the simply supported beam structural mechanics model comprising the common cab framework structure illustrated by FIG. 5 is:

$$2 \cdot ( {M}_{pillar} + {M}_{top \_ cross beam} ) = F \cdot L$$

The bending moment equilibrium formula of the simply supported beam structural mechanics model comprising the framework structure reinforced with the middle cross beam illustrated by FIG. 6 is:

$$2 \cdot ( {M}_{pillar} + {M}_{top \_ cross beam} + {M}_{middle \_ cross beam} ) = F \cdot L$$

The bending moment equilibrium formula of the simply supported beam structural mechanics model comprising the framework structure reinforced with the cable-stayed beams illustrated by FIG. 7 is:

$$2 \cdot ( {M}_{pillar} + {M}_{top \_ cross beam} ) = F \cdot {L}_{d}$$

Where, Mₚᵢₗₗₐᵣ, M_{top_cross beam} and M_{middle_cross beam} are the resisting moment of plastic hinges of pillars, the resisting moment of plastic hinges of top cross beams, and the resisting moment of plastic hinges of the middle cross beam respectively, F is a lateral load of a simply supported beam structure, and L is a height dimension of the pillars; L_{d} a height dimension from highest points of D-pillars to highest points of the cable-stayed beams of the framework structure reinforced with the cable-stayed beams;
S2, selecting design parameters: analyzing the bending moment equilibrium formula to obtain a profile anti-bending geometric parameter, sectional modulus W, which is a key factor determining a maximum load capacity Mₘₐₓ of ROPS framework profiles, wherein a relation between the sectional modulus W and the maximum load capacity Mₘₐₓ is Mₘₐₓ=K·σₜₑₙₛᵢₗₑₛₜᵣₑₛₛ·W;

Substituting Mₘₐₓ=K·σₜₑₙₛᵢₗₑₛₜᵣₑₛₛ·W into the bending moment equilibrium formula obtained in S1 to obtain a maximum lateral load formula of the ROPS framework;

The maximum lateral load formula of the common cab framework structure illustrated by FIG. 5:

$${F}_{max} = 2 \cdot K \cdot {σ}_{tensile stress} \cdot ( {W}_{pillar} + {W}_{top \_ cross beam} ) / L$$

The maximum lateral load formula of the framework structure reinforced with the middle cross beam illustrated by FIG. 6:

$${F}_{max} = 2 \cdot K \cdot {σ}_{tensile stress} \cdot ( {W}_{pillar} + {W}_{top \_ cross beam} + {W}_{middle \_ cross beam} ) / L$$

The maximum lateral load formula of the framework structure reinforced with the cable-stayed beams illustrated by FIG. 7:

$${F}_{max} = 2 \cdot K \cdot {σ}_{tensile stress} \cdot ( {W}_{pillar} + {W}_{top \_ cross beam} ) / {L}_{d}$$

S3, establishing an ROPS test database, obtaining test data when the framework profiles enter a complete deformation zone during the ROPS lateral thrust test, and extracting the maximum lateral load Fₘₐₓ, the maximum lateral load energy Uₘₐₓ and the maximum deformation displacement Sₘₐₓ in the test data, wherein the maximum deformation displacement Sₘₐₓ, which is a median of normal statistical data, is 0.28 m;
S4, establishing a relation, obtaining the value of K in the relation established in S2 by regression analysis according to the maximum lateral load Fₘₐₓ extracted from the test data to obtain a maximum lateral load Fₘₐₓ quick calculation formula of the ROPS framework, which is expressed as:

$${F}_{max} = 2 \cdot K \cdot {σ}_{tensile stress} \cdot \sum \{ ( \sum \{ ( {W}_{A \_ pillar} + {W}_{top \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ Dcross beam} ) / {L}_{D} \}$$

Where, n is a structure reinforcing coefficient;
Common cab framework structure illustrated by FIG. 5: n=1;
Framework structure reinforced with the middle cross beam illustrated by FIG. 6:

$$n = ( {W}_{pillar} + {W}_{top \_ cross beam} + {W}_{middle \_ cross beam} ) / ( {W}_{D \_ pillar} + {W}_{top \_ Dcross beam} ) ;$$

Framework structure reinforced with the cable-stayed beams illustrated by FIG. 7: n=L_{D}/L_{d};
Obtaining, by statistically analyzing a relation curve of the lateral load F and lateral deformation displacement S in a database established in S3, that load energy absorbed in the plastic deformation zone accounts for ⅔ of total load energy, displacement in the plastic deformation zone accounts for ½ of total deformation displacement, that is, ⅔·Uₘₐₓ=½·Fₘₐₓ·Sₘₐₓ, and the maximum deformation displacement Sₘₐₓ, which is the median of the normal statistic data, is 0.28 m, such that a maximum load energy Uₘₐₓ quick calculation formula is obtained and expressed as:

$${U}_{max} = 0 \text{.75} \cdot {F}_{max} \cdot {S}_{max} = 1.5 \cdot {S}_{max} \cdot K \cdot {σ}_{tensile stress} \cdot \sum \{ ( {W}_{A \_ pillar} + {W}_{top \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ Dcross beam} ) / {L}_{D} \} = 0.42 \cdot K \cdot {σ}_{tensile stress} \cdot \\ \sum \{ ( {W}_{A \_ pillar} + {W}_{top \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ Dcross beam} ) / {L}_{D} \}$$

Where, n is a structure reinforcing coefficient and is determined according to a selected cab framework structure type;
Target values of the lateral load Fₘₐₓ and the lateral load energy Uₘₐₓ obtained by calculation are used as Fₘₐₓ and Uₘₐₓ;
K denotes a complete plastic deformation zone reinforcing coefficient and is obtained by regression analysis according to the maximum lateral load Fₘₐₓ in test data;
The maximum deformation displacement Sₘₐₓ is the median of the normal statistical data in test data;
σ_{tensile stress} denotes a tensile stress limit value of a material and is a fixed value according to the selected material;
L_{A}, L_{B}, L_{D}and L_{d} are given values according to the selected cab framework structure type, and respectively denote a height dimension of A-pillars, a height dimension of B-pillars, a height dimension of D-pillars, and a height dimension from highest points of D-pillars to highest points of cable-stayed beams of the framework structure reinforced with the cable-stayed beams;
S5, determining the scope of applicable machines of ROPS frameworks: reasonably classifying the load capacity of series cab ROPS framework to different levels based on the lightweight and universal principle, and determining the scope of applicable machines of the ROPS frameworks;
S6, calculating load requirements, and determining, according to formulas specified in GB/T 17922, GB/T 19930 or GB/T19930.2, target values of the lateral load Fₘₐₓ and the lateral load energy Uₘₐₓ of the ROPS framework according to the maximum mass of the applicable machines of the ROPS framework;

TABLE 1

| | | | | |
|---|---|---|---|---|
| | | | Vertical | |
| Machine | Lateral load F | Lateral load energy U | load F | Longitudinal load F |
| mass M kg | N | J | N | N |

GB/T 17922
1) Crawler-type tractor and loader

| | | | | |
|---|---|---|---|---|
| 700 <M [symbol] 4630 4 630 < M [symbol] 59 500 | 6M $70 \; 000 {( \frac{M}{10 \; 000} )}^{\text{?}}$ | $13 \; 000 {( \frac{M}{10 \; 000} )}^{\text{?}}$ | 19.61M | 4.8M $56 \; 000 {( \frac{M}{10 \; 000} )}^{\text{?}}$ |
| M > 59 500 | 10M | 2.03M | | 8M |

2) Land leveler

| | | | | |
|---|---|---|---|---|
| 700 < M [symbol] 2 140 2 140 < M [symbol] 38 010 | 6M $70 \; 000 {( \frac{M}{10 \; 000} )}^{\text{?}}$ | $16 \; 000 {( \frac{M}{10 \; 000} )}^{\text{?}}$ | 19.61M | 4.8M $56 \; 000 {( \frac{M}{10 \; 000} )}^{\text{?}}$ |
| M > 38 010 | 8M | 2.09M | | 6.4M |

3) Wheel loader, wheel tractor and transformation equipment thereof for grinding, wheel dozer, skid steer loader and loader-digger

| | | | | |
|---|---|---|---|---|
| 700 < M [symbol] 10 000 10 000 < M [symbol] 128 600 | 6M $60 \; 000 {( \frac{M}{10 \; 000} )}^{\text{?}}$ | $12 \; 500 {( \frac{M}{10 \; 000} )}^{\text{?}}$ | 19.61M | 4.8M $48 \; 000 {( \frac{M}{10 \; 000} )}^{\text{?}}$ |
| M > 128 600 | 10M | 2.37M | | 8M |

4) Industrial wheel tractor

| | | | | |
|---|---|---|---|---|
| 700 < M [symbol] 10 000 10 000 < M [symbol] 128 600 | 6M $60 \; 000 {( \frac{M}{10 \; 000} )}^{\text{?}}$ | $12 \; 500 {( \frac{M}{10 \; 000} )}^{\text{?}}$ | 19.61M | 4.8M⁰ $48 \; 000 {( \frac{M}{10 \; 000} )}^{\text{?}}$ |
| M > 128 600 | 10M | 2.37M | | 8M |

5) Tractor-driven machines: self-propelled scraper, water-transport truck, articulated steering dumper, bottom dumper, side dumper, tail
dumper and five-wheel instrument

| | | | | |
|---|---|---|---|---|
| 700 < M [symbol] 1 010 1 010 < M [symbol] 32 160 | 6M $95 \; 000 {( \frac{M}{10 \; 000} )}^{\text{?}}$ | $20 \; 000 {( \frac{M}{10 \; 000} )}^{\text{?}}$ | 19.61M | 4.8M $76 \; 000 {( \frac{M}{10 \; 000} )}^{\text{?}}$ |
| M > 32 160 | 12M | 2.68M | | 9.6M |

6) Road roller and tamper (the mass M does not include loose attachments

| | | | | |
|---|---|---|---|---|
| 700 < M [symbol] 10 000 10 000 < M [symbol] 53 780 | 5M $50 \; 000 {( \frac{M}{10 \; 000} )}^{\text{?}}$ | $9 \; 500 {( \frac{M}{10 \; 000} )}^{\text{?}}$ | 19.61M | 4M $40 \; 000 {( \frac{M}{10 \; 000} )}^{\text{?}}$ |
| M > 53 780 | 7M | 1.45M | | 5.6M |

7) Integrated dumper - ROPS only (the mass M does not include the dumper carriage and the loading mass)

| | | | | |
|---|---|---|---|---|
| 700 < M [symbol] 1 750 1 750 < M [symbol] 22 540 | 6M $85 \; 000 {( \frac{M}{10 \; 000} )}^{\text{?}}$ | $15 \; 000 {( \frac{M}{10 \; 000} )}^{\text{?}}$ | 19.61M | 4.8M $68 \; 000 {( \frac{M}{10 \; 000} )}^{\text{?}}$ |
| 22 540 < M [symbol] | 10M | 1.84M | | 8M |
| 58 960 | | | | |
| 58 960 < M [symbol] 111 650 | $413 \; 500 {( \frac{M}{10 \; 000} )}^{\text{?}}$ | $61 \; 450 {( \frac{M}{10 \; 000} )}^{\text{?}}$ | | $330 \; 800 {( \frac{M}{10 \; 000} )}^{\text{?}}$ |
| M > 111 650 | 6M | 1.19M | | 4.8M |

8) Integrated dumper - dumper carriage only (the mass M includes the dumper body, but does not include the loading mass)

| | | | | |
|---|---|---|---|---|
| 700 < M [symbol] 10 000 | 6M | $6 \; 000 {( \frac{M}{10 \; 000} )}^{\text{?}}$ | 19.61M | 4.8M $48 \; 000 {( \frac{M}{10 \; 000} )}^{\text{?}}$ |
| 10 000 < M [symbol] 21 610 | $60 \; 000 {( \frac{M}{10 \; 000} )}^{\text{?}}$ | | | |
| 21 610 < | 7M | 0.73M | | 5.6M |
| M [symbol] | | | | |
| 93 900 | | | | |
| 93 900 < M [symbol] 113 860 | $420 \; 000 {( \frac{M}{10 \; 000} )}^{\text{?}}$ | $16 \; 720 {( \frac{M}{10 \; 000} )}^{\text{?}}$ | | $336 \; 000 {( \frac{M}{10 \; 000} )}^{\text{?}}$ |
| M > 113 860 | 6M | 0.68M | | 4.8M |

GB/T 19930

| | |
|---|---|
| Lateral load energy/J | Longitudinal load energy/J |
| $13 \; 000 {( \frac{m}{10 \; 000} )}^{\text{?}}$ | $4 \; 300 {( \frac{m}{10 \; 000} )}^{\text{?}}$ |

$\text{?} \text{indicates text missing or illegible when filed}$

TABLE 2
GB/T 19930.2

| | |
|---|---|
| Lateral load energy U [symbol] /J | 13 000 [symbol] (M/10 000) [symbol] |
| Lateral load F [symbol] /N | 35 000 [symbol] (M/10 000) [symbol] |
| Longitudinal load energy U [symbol] /J | 4 300 [symbol] (M/10 000) [symbol] |
| Vertical load F [symbol] /N | 12.75M |

[symbol]

indicates data missing or illegible when filed

S7, selecting a framework structure: selecting, according to features of applicable machines of a cab, a suitable cab framework structure type from a simply supported beam structural mechanics model.
S8, calculating profile sectional parameters, and according to the relation established in S4, the target values of the lateral load Fₘₐₓ and the lateral load energy Uₘₐₓ calculated in S6 and the framework structure selected in S7, obtaining a profile sectional modulus sum Σ(Wₚᵢₗₗₐᵣ, W_{top_cross beam}, W_{middle_cross beam}) meeting the relation;

Based on the framework structure type selected from the simply supported beam structural mechanics model and the target values of the lateral load Fₘₐₓ and the lateral load energy Uₘₐₓ of the ROPS framework obtained by calculation, obtaining two profile sectional modulus sum values by calculation according to the maximum lateral load Fₘₐₓ quick calculation formula and the maximum load energy Uₘₐₓ quick calculation formula, and taking the greater one of the two profile sectional modulus sum values as a final profile sectional modulus sum Σ(Wₚᵢₗₗₐᵣ, W_{top_cross beam}) or Σ(Wₚᵢₗₗₐᵣ, W_{top_cross beam}, W_{middle_cross beam}) meeting the relation;

$${U}_{max} = 0.42 \cdot K \cdot {σ}_{tensile stress} \cdot \sum \{ ( {W}_{A \_ pillar} + {W}_{top \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ Dcross beam} ) / {L}_{D} \}$$

$${F}_{max} = 2 \cdot K \cdot {σ}_{tensile stress} \cdot \sum \{ ( \sum \{ ( {W}_{A \_ pillar} + {W}_{top \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ Dcross beam} ) / {L}_{D} \}$$

Where, n is a structure reinforcing coefficient and is determined according to the selected cab framework structure type;
Common cab framework structure: n=1;
Framework structure reinforced with a middle cross beam: n=(Wₚᵢₗₗₐᵣ+W_{top_cross beam}+W_{middle_cross beam})/(W_{D_pillar}+W_{top_Dcrossbeam});
Framework structure reinforced with cable-stayed beams: n=L_{D}/L_{d};
The target values of the lateral load Fₘₐₓ and the lateral load energy Uₘₐₓ obtained by calculation are used as Fₘₐₓ and Uₘₐₓ;
K denotes a complete plastic deformation zone reinforcing coefficient, is obtained by regression analysis according to the maximum lateral load Fₘₐₓ in test data, and is a fixed value;
σ_{tensile stress} denotes a tensile stress limit value of a material and is a fixed value according to the selected material;
L_{A}, L_{B}, L_{D} and L_{d} are given values according to the selected cab framework structure. type;
S9, selecting suitable profiles according to the profile sectional modulus sum Σ(Wₚᵢₗₗₐᵣ, W_{top_cross beam}) or Σ(Wₚᵢₗₗₐᵣ, W_{top_cross beam}, W_{middle_cross beam}) obtained by calculation in S8, and constructing a closed spatial framework structure according to the framework structure type selected in S7.

ROPS test data obtained by simulation analysis and verified by tests are fed back to the database established in S3, and relation in S4 is amended with a large amount of test data, such that lightweight and accurate design of the ROPS framework is realized.

The profile sectional modulus sum Σ(Wₚᵢₗₗₐᵣ, W_{top_cross beam}, W_{middle_cross beam}) of the ROPS framework can be calculated according to the lateral load Fₘₐₓ and the lateral load energy Uₘₐₓ, and the maximum lateral load Fₘₐₓ and the maximum lateral load energy Uₘₐₓ of the ROPS framework can be calculated according to the profile sectional modulus sum Σ(Wₚᵢₗₗₐᵣ, W_{top_cross beam}, W_{middle_cross beam}) of the ROPS framework, such that contrastive analysis and verification of multiple schemes are realized.

According to the relation established in S4, the selection of profiles and the comparison of multiple schemes can be performed by manual computation, and the design time of the ROPS framework is controlled within 4 hours, such that the design cycle is greatly shortened.

As required by the database, the ROPS framework profiles should enter the complete plastic deformation zone, such that limit values of the load capacity of the profiles are fully used; and based on the database, the relation in S4 is established, and profiles are selected, such that lightweight design of the ROPS framework is realized, and the design quality is improved.

### Embodiment 3

A cab for engineering machines comprises the ROPS framework in Embodiment 1, which is designed through the design method for the ROPS framework in Embodiment 2.

The engineering machines may be hydraulic excavators, loaders, road rollers, land levelers and the like, and have all the advantages of the ROPS framework provided by the embodiments of the disclosure.

The above embodiments are merely preferred ones of the invention. It should be pointed out that those skilled in the art can make various improvements and embellishments without departing from the principle of the invention, and all these improvements and embellishments should also fall within the protection scope of the invention.

1. A design method for an ROPS framework comprising the following steps:
obtaining, by calculation specified in GB/T 17922, GB/T 19930 or GB/T19930.2, target values of a lateral load Fₘₐₓ and lateral load energy Uₘₐₓ of an ROPS framework according to maximum mass of applicable machines of the ROPS framework;
selecting, according to features of applicable machines of a cab, a suitable cab framework structure type from a simply supported beam structural mechanics model, wherein the simply supported beam structural mechanics model comprises a common cab framework structure, a framework structure reinforced with a middle cross beam, or a framework structure reinforced with cable-stayed beams;
based on the suitable framework structure type selected from the simply supported beam structural mechanics model and the target values of the lateral load Fₘₐₓ and the lateral load energy Uₘₐₓ obtained by calculation, obtaining two profile sectional modulus sum values by calculation according to a maximum lateral load Fₘₐₓ quick calculation formula and a maximum load energy Uₘₐₓ quick calculation formula, and taking the greater one of the two profile sectional modulus sum values as a final profile sectional modulus sum of all pillars and top cross beams meeting a relation; and
selecting suitable profiles according to the profile sectional modulus sum, and constructing a closed spatial framework structure according to the selected cab framework structure type,

2. The design method for an ROPS framework according to claim 1, wherein,
the maximum lateral load Fₘₐₓ quick calculation formula is:
$${F}_{max} = 2 \cdot K \cdot {σ}_{tensile stress} \cdot \sum \{ ( \sum \{ ( {W}_{A \_ pillar} + {W}_{top \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ Dcross beam} ) / {L}_{D} \} ;$$
the maximum load energy Uₘₐₓ quick calculation formula is:
$${U}_{max} = 1.5 \cdot {S}_{max} \cdot K \cdot {σ}_{tensile stress} \cdot \sum \{ ( {W}_{A \_ pillar} + {W}_{top \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ Dcross beam} ) / {L}_{D} \} = 0.42 \cdot K \cdot {σ}_{tensile stress} \cdot \\ \sum \{ ( {W}_{A \_ pillar} + {W}_{top \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ Dcross beam} ) / {L}_{D} \} ;$$
where, n is a structure reinforcing coefficient and is determined according to the selected cab framework structure type;
the target values of the lateral load Fₘₐₓ and the lateral load energy Uₘₐₓ obtained by calculation are used as Fₘₐₓ and Uₘₐₓ;
K denotes a complete plastic deformation zone reinforcing coefficient and is obtained by regression analysis according to the maximum lateral load Fₘₐₓ in test data;
the maximum deformation displacement Sₘₐₓ is a median of normal statistical data in the test data;
σ_{tensile stress} denotes a tensile stress limit value of a material and is a fixed value according to the selected material;
L_{A}, L_{B}, L_{D} and L_{d} are given values according to the selected cab framework structure type, and respectively denote a height dimension of A-pillars, a height dimension of B-pillars, a height dimension of D-pillars, and a height dimension from highest points of D-pillars to highest points of cable-stayed beams of the framework structure reinforced with the cable-stayed beams.

3. The design method for an ROPS framework according to claim 2, wherein,
n is the structure reinforcing coefficient and is determined according to the selected cab framework structure type;
common cab framework structure: n=1;
framework structure reinforced with a middle cross beam: n=(Wₚᵢₗₗₐᵣ+W_{top_cross beam}+W_{middle_cross beam})/(W_{D_pillar}+W_{top_Dcrossbeam});
framework structure reinforced with cable-stayed beams: n=L_{D}/L_{d}.

4. The design method for an ROPS framework according to claim 1, wherein,
the maximum lateral load Fₘₐₓ quick calculation formula and the maximum load energy Uₘₐₓ quick calculation formula are established by:
S1, establishing a mechanics model: with a lateral load F and lateral load energy U required by an ROPS test as design objectives, establishing a relation of the lateral load F and the lateral load energy U with profile anti-bending geometric parameters to obtain the simply supported beam structural mechanics model, and obtaining a bending moment equilibrium formula by analysis with the simply supported beam structural mechanics model, wherein the sum of resisting moments of plastic hinges is a bending moment generated by the load;
S2, selecting design parameters: analyzing the bending moment equilibrium formula to obtain a profile anti-bending geometric parameter, sectional modulus W, which is a key factor determining a maximum load capacity Mₘₐₓ of ROPS framework profiles, wherein a relation between the sectional modulus W and the maximum load capacity Mₘₐₓ is Mₘₐₓ=K·σₜₑₙₛᵢₗₑₛₜᵣₑₛₛ·W;
substituting Mₘₐₓ=K·σₜₑₙₛᵢₗₑₛₜᵣₑₛₛ·W into the bending moment equilibrium formula obtained in S1 to obtain a maximum lateral load formula of the ROPS framework;
S3, obtaining test data when the framework profiles enter a complete deformation zone during the ROPS lateral thrust test, extracting the maximum lateral load Fₘₐₓ, the maximum lateral load energy Uₘₐₓ and the maximum deformation displacement Sₘₐₓ in the test data, and using a median of normal statistical data in the test data as the maximum deformation displacement Sₘₐₓ;
S4, obtaining the value of K in the relation established in S2 by regression analysis according to the maximum lateral load Fₘₐₓ extracted from the test data to obtain the maximum lateral load Fₘₐₓ quick calculation formula of the ROPS framework, which is expressed as:
$${F}_{max} = 2 \cdot K \cdot {σ}_{tensile stress} \cdot \sum \{ ( \sum \{ ( {W}_{A \_ pillar} + {W}_{t op \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ D cross beam} ) / {L}_{D} \}$$
where, n is a structure reinforcing coefficient;
common cab framework structure: n=1;
framework structure reinforced with a middle cross beam: n=(Wₚᵢₗₗₐᵣ+W_{top_cross beam}+W_{middle_cross beam})/(W_{D_pillar}+W_{top_Dcrossbeam});
framework structure reinforced with cable-stayed beams: n=L_{D}/L_{d};
obtaining, by statistically analyzing a relation curve of the lateral load F and lateral deformation displacement S in a database established in S3, that load energy absorbed in the plastic deformation zone accounts for ⅔ of total load energy, displacement in the plastic deformation zone accounts for ½ of total deformation displacement and the maximum deformation displacement Sₘₐₓ, which is the median of the normal statistic data, is 0.28 m, such that the maximum load energy Uₘₐₓ quick calculation formula is obtained and expressed as:
$${U}_{max} = 0.75 \cdot {F}_{max} \cdot {S}_{max} = 1.5 \cdot {S}_{max} \cdot K \cdot {σ}_{tensile stress} \cdot \sum \{ ( {W}_{A \_ pillar} + {W}_{t op \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ D cross beam} ) / {L}_{D} \} = 0.42 \cdot K \cdot {σ}_{tensile stress} \cdot \sum \{ ( {W}_{A \_ pillar} + {W}_{t op \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ D cross beam} ) / {L}_{D} \} .$$

5. The design method for an ROPS framework according to claim 4, wherein,
in S1, the simply supported beam structural mechanics model comprises a common cab framework structure, a framework structure reinforced with a middle cross beam, or a framework structure reinforced with cable-stayed beams;
the bending moment equilibrium formula of the simply supported beam structural mechanics model comprising the common cab framework structure is:
$$2 \cdot ( {M}_{pillar} + {M}_{t op \_ cross beam} ) = F \cdot L ; .$$
the bending moment equilibrium formula of the simply supported beam structural mechanics model comprising the framework structure reinforced with the middle cross beam is:
$$2 \cdot ( {M}_{pillar} + {M}_{t op \_ cross beam} + {M}_{middle\_cross beam} ) = F \cdot L ; .$$
the bending moment equilibrium formula of the simply supported beam structural mechanics model comprising the framework structure reinforced with the cable-stayed beams is:
$$2 \cdot ( {M}_{pillar} + {M}_{t op \_ cross beam} ) = F \cdot {L}_{d} ; .$$
where, Mₚᵢₗₗₐᵣ, M_{top_cross beam} and M_{middle_cross beam} are the resisting moment of plastic hinges of pillars, the resisting moment of plastic hinges of top cross beams, and the resisting moment of plastic hinges of the middle cross beam respectively, F is a lateral load of a simply supported beam structure, and L is a height dimension of the pillars;
in S2, the maximum lateral load formula of the ROPS framework is:
a) the maximum lateral load formula of the common cab framework structure:
Fₘₐₓ=2·K·σ_{tensile stress}·(Wₚᵢₗₗₐᵣ+W_{top_cross beam})/L;
b) the maximum lateral load formula of the framework structure reinforced with the middle cross beam:
$${F}_{max} = 2 \cdot K \cdot {σ}_{tensile stress} \cdot ( {W}_{pillar} + {W}_{t op \_ cross beam} + {W}_{middle \_ cross beam} ) / L ; .$$
c) the maximum lateral load formula of the framework structure reinforced with the cable-stayed beams:
$${F}_{max} = 2 \cdot K \cdot {σ}_{tensile stress} \cdot ( {W}_{pillar} + {W}_{t op \_ cross beam} ) / {L}_{d} .$$

6. The design method for an ROPS framework according to claim 4, wherein,
in S3, the maximum deformation displacement Sₘₐₓ, which is the median of the normal statistic data, is 0.28 m.

7. An axially symmetric common cab ROPS framework designed through the design method for an ROPS framework according to claim 1, comprising pillars, cross beams and longitudinal beams, wherein,
the pillars comprise A-pillars, B-pillars and D-pillars; the cross beams comprise top cross beams and bottom cross beams; the longitudinal beams comprise top longitudinal beams and bottom longitudinal beams;
the two A-pillars are connected through a first top cross beam and a first bottom cross beam to form a closed rectangular A-ring;
the two B-pillars are connected through a second top cross beam and a second bottom cross beam to form a closed rectangular B-ring;
the two D-pillars are connected through a third top cross beam and a third bottom cross beam to form a closed rectangular D-ring;
four corners of the A-ring and corresponding four corners of the B-ring are connected through a first top longitudinal beam and a first bottom longitudinal beam, and four corners of the B-ring and four corresponding corners of the D-ring are connected through a second top longitudinal beam and a second bottom longitudinal beam, such that a closed spatial framework structure is formed.

8. An axially symmetric ROPS framework reinforced with a middle cross beam and designed through the design method for an ROPS framework according to claim 1, comprising pillars, cross beams, longitudinal beams and a middle cross beam, wherein,
the pillars comprise A-pillars, B-pillars and D-pillars; the cross beams comprise top cross beams and bottom cross beams; the longitudinal beams comprise top longitudinal beams and bottom longitudinal beams;
the two A-pillars are connected through a first top cross beam and a first bottom cross beam to form a closed rectangular A-ring;
the two B-pillars are connected through a second top cross beam and a second bottom cross beam to form a closed rectangular B-ring;
the two D-pillars are connected through a third top cross beam and a third bottom cross beam to form a closed rectangular D-ring; two ends of the middle cross beam are connected to inner sides of middle portions of the two D-pillars respectively, and the third top cross beam, the middle cross beam and the third bottom cross beam are arranged in parallel;
four corners of the A-ring and corresponding four corners of the B-ring are connected through a first top longitudinal beam and a first bottom longitudinal beam, and four corners of the B-ring and four corresponding corners of the D-ring are connected through a second top longitudinal beam and a second bottom longitudinal beam, such that a closed spatial framework structure is formed.

9. An axially symmetric ROPS framework reinforced with cable-stayed beams and designed through the design method for an ROPS framework according to claim 1, comprising pillars, cross beams, longitudinal beams and two cable-stayed beams, wherein,
the pillars comprise A-pillars, B-pillars and D-pillars; the cross beams comprise top cross beams and bottom cross beams; the longitudinal beams comprise top longitudinal beams and bottom longitudinal beams;
the two A-pillars are connected through a first top cross beam and a first bottom cross beam to form a closed rectangular A-ring;
the two B-pillars are connected through a second top cross beam and a second bottom cross beam to form a closed rectangular B-ring;
the two D-pillars are connected through a third top cross beam and a third bottom cross beam to form a closed rectangular D-ring;
each said cable-stayed beam has an end connected to an inner side of a middle of one said D-pillar and an end connected to the third bottom cross beam;
four corners of the A-ring and corresponding four corners of the B-ring are connected through a first top longitudinal beam and a first bottom longitudinal beam, and four corners of the B-ring and four corresponding corners of the D-ring are connected through a second top longitudinal beam and a second bottom longitudinal beam, such that a closed spatial framework structure is formed.

10. A cab for engineering machines, comprising the ROPS framework according to claim 7.

11. The design method for an ROPS framework according to claim 2, wherein,
the maximum lateral load Fₘₐₓ quick calculation formula and the maximum load energy Uₘₐₓ quick calculation formula are established by:
S1, establishing a mechanics model: with a lateral load F and lateral load energy U required by an ROPS test as design objectives, establishing a relation of the lateral load F and the lateral load energy U with profile anti-bending geometric parameters to obtain the simply supported beam structural mechanics model, and obtaining a bending moment equilibrium formula by analysis with the simply supported beam structural mechanics model, wherein the sum of resisting moments of plastic hinges is a bending moment generated by the load;
S2, selecting design parameters: analyzing the bending moment equilibrium formula to obtain a profile anti-bending geometric parameter, sectional modulus W, which is a key factor determining a maximum load capacity Mₘₐₓ of ROPS framework profiles, wherein a relation between the sectional modulus W and the maximum load capacity Mₘₐₓ is Mₘₐₓ=K·σₜₑₙₛᵢₗₑₛₜᵣₑₛₛ·W;
substituting Mₘₐₓ=K·σₜₑₙₛᵢₗₑₛₜᵣₑₛₛ·W into the bending moment equilibrium formula obtained in S1 to obtain a maximum lateral load formula of the ROPS framework;
S3, obtaining test data when the framework profiles enter a complete deformation zone during the ROPS lateral thrust test, extracting the maximum lateral load Fₘₐₓ, the maximum lateral load energy Uₘₐₓ and the maximum deformation displacement Sₘₐₓ in the test data, and using a median of normal statistical data in the test data as the maximum deformation displacement Sₘₐₓ;
S4, obtaining the value of K in the relation established in S2 by regression analysis according to the maximum lateral load Fₘₐₓ extracted from the test data to obtain the maximum lateral load Fₘₐₓ quick calculation formula of the ROPS framework, which is expressed as:
$${F}_{max} = 2 \cdot K \cdot {σ}_{tensile stress} \cdot \sum \{ ( \sum \{ ( {W}_{A \_ pillar} + {W}_{t op \_ Across beam} ) / {L}_{A} , ( {W}_{B \_ pillar} + {W}_{top \_ Bcross beam} / {L}_{B} , n \cdot ( {W}_{D \_ pillar} + {W}_{top \_ D cross beam} ) / {L}_{D} \} .$$
where, n is a structure reinforcing coefficient;
common cab framework structure: n=1;
framework structure reinforced with a middle cross beam: n=(Wₚᵢₗₗₐᵣ+W_{top_cross beam}+W_{middle_cross beam})/(W_{D_pillar}+W_{top_Dcrossbeam});
framework structure reinforced with cable-stayed beams: n=L_{D}/L_{d};
obtaining, by statistically analyzing a relation curve of the lateral load F and lateral deformation displacement S in a database established in S3, that load energy absorbed in the plastic deformation zone accounts for ⅔ of total load energy, displacement in the plastic deformation zone accounts for ½ of total deformation displacement and the maximum deformation displacement Sₘₐₓ, which is the median of the normal statistic data, is 0.28 m, such that the maximum load energy Uₘₐₓ quick calculation formula is obtained and expressed as:
$${U}_{max} = 0.75 \cdot {F}_{max} \cdot {S}_{max} = 1.5 \cdot {S}_{max} \cdot K \cdot {σ}_{tensile stress} \cdot \sum \{ ( {W}_{A \_ pillar} + {W}_{t op \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ D cross beam} ) / {L}_{D} \} = 0.42 \cdot K \cdot {σ}_{tensile stress} \cdot \sum \{ ( {W}_{A \_ pillar} + {W}_{t op \_ Across beam} ) / {L}_{A} , ( {W}_{B \_ pillar} + {W}_{top \_ Bcross beam} ) / {L}_{B} , n \cdot ( {W}_{D \_ pillar} + {W}_{top \_ D cross beam} ) / {L}_{D} \} .$$

12. The design method for an ROPS framework according to claim 11, wherein,
in S1, the simply supported beam structural mechanics model comprises a common cab framework structure, a framework structure reinforced with a middle cross beam, or a framework structure reinforced with cable-stayed beams;
the bending moment equilibrium formula of the simply supported beam structural mechanics model comprising the common cab framework structure is:
$$2 \cdot ( {M}_{pillar} + {M}_{t op \_ cross beam} ) = F \cdot L ; .$$
the bending moment equilibrium formula of the simply supported beam structural mechanics model comprising the framework structure reinforced with the middle cross beam is:
$$2 \cdot ( {M}_{pillar} + {M}_{t op \_ cross beam} + {M}_{middle\_cross beam} ) = F \cdot L ; .$$
the bending moment equilibrium formula of the simply supported beam structural mechanics model comprising the framework structure reinforced with the cable-stayed beams is:
$$2 \cdot ( {M}_{pillar} + {M}_{t op \_ cross beam} ) = F \cdot {L}_{d} ; .$$
where, Mₚᵢₗₗₐᵣ, M_{top_cross beam} and M_{middle_cross beam} are the resisting moment of plastic hinges of pillars, the resisting moment of plastic hinges of top cross beams, and the resisting moment of plastic hinges of the middle cross beam respectively, F is a lateral load of a simply supported beam structure, and L is a height dimension of the pillars;
in S2, the maximum lateral load formula of the ROPS framework is:
a) the maximum lateral load formula of the common cab framework structure:
$${F}_{max} = 2 \cdot K \cdot {σ}_{tensile stress} \cdot ( {W}_{pillar} + {W}_{t op \_ cross beam} ) / L ; .$$
b) the maximum lateral load formula of the framework structure reinforced with the middle cross beam:
$${F}_{max} = 2 \cdot K \cdot {σ}_{tensile stress} \cdot ( {W}_{pillar} + {W}_{t op \_ cross beam} + {W}_{middle\_ cross beam} ) / L ; .$$
c) the maximum lateral load formula of the framework structure reinforced with the cable-stayed beams:
$${F}_{max} = 2 \cdot K \cdot {σ}_{tensile stress} \cdot ( {W}_{pillar} + {W}_{t op \_ cross beam} ) / {L}_{d} .$$

13. The design method for an ROPS framework according to claim 11, wherein,
in S3, the maximum deformation displacement Sₘₐₓ, which is the median of the normal statistic data, is 0.28 m.
